(19) United States
(12) Patent Application Publication
(10) Pub. No.: US 2025/0016859 A1
(43) Pub. Date: Jan. 9, 2025

(54) MULTI-ACCESS PROTOCOL DATA UNIT SESSION ACCESS TYPE USAGE

(71) Applicants: Lenovo (Singapore) Pte. Ltd., New Tech Park (SG); LENOVO INTERNATIONAL COÖPERATIEF U.A., EE Amsterdam (SG)

(72) Inventors: Genadi Velev, Darmstadt (DE); Apostolis Salkintzis, Athens (GR); Dimitrios Karampatsis, Ruislip (GB)

(21) Appl. No.: 18/707,686

(22) PCT Filed: Dec. 9, 2021
(86) PCT No.: PCT/EP2021/085092

§ 371 Date: May 6, 2024

(30) Foreign Application Priority Data
Nov. 5, 2021 (GR) 20210100773

(51) Int. Cl. H04W 76/15; H04W 48/16; H04W 60/00; H04W 76/18

(52) U.S. Cl. CPC H04W 76/15; H04W 48/16; H04W 60/005; H04W 76/18

(57) ABSTRACT

Apparatuses, methods, and systems are disclosed for multi-access protocol data unit session access type usage. One method includes sending, to a network, a first request message to establish a multi-access protocol data unit session via a first access type. The method includes receiving a response message including an indication for a user plane restriction for a restricted access type. The method includes determining to use user plane resources only over a non-restricted access type.

### FIELD

The subject matter disclosed herein relates generally to wireless communications and more particularly relates to multi-access protocol data unit session access type usage.

### BACKGROUND

In certain wireless communications networks, a multi-access protocol data unit session may be used. In such networks, certain access types may be unavailable.

### BRIEF SUMMARY

Methods for multi-access protocol data unit session access type usage are disclosed. Apparatuses and systems also perform the functions of the methods. One embodiment of a method includes sending, from a user equipment to a network, a first request message to establish a multi-access protocol data unit session via a first access type. In some embodiments, the method includes receiving a response message including an indication for a user plane restriction for a restricted access type. In certain embodiments, the method includes determining to use user plane resources only over a non-restricted access type.

One apparatus for multi-access protocol data unit session access type usage includes a user equipment. In some embodiments, the apparatus includes a transmitter that sends, to a network, a first request message to establish a multi-access protocol data unit session via a first access type. In various embodiments, the apparatus includes a receiver that receives a response message including an indication for a user plane restriction for a restricted access type. In certain embodiments, the apparatus includes a processor that determines to use user plane resources only over a non-restricted access type.

Another embodiment of a method for multi-access protocol data unit session access type usage includes receiving, at a network function, a first request message from an access management function, the first request message including: a second request message from a user equipment to establish a multi-access protocol data unit session with a first network slice subject to network slice admission control; and a first indication that the user equipment is registered for a first access type and a second access type. In some embodiments, the method includes determining, based on information received from a network slice admission control function, that a restricted access type is unavailable for the first network slice. In certain embodiments, the method includes transmitting a first response message to the user equipment, the first response message indicating that the multi-access protocol data unit session is accepted and a user plane restriction for the restricted access type applies.

Another apparatus for multi-access protocol data unit session access type usage includes a network function. In some embodiments, the apparatus includes a transmitter that communicates with one or more network functions in a mobile communication network. In various embodiments, the apparatus includes a processor that: receives a first request from an access management function in the mobile communication network, the first request comprising a second request sent by a user equipment, wherein the second request indicates that a multiaccess data connection over a plurality of access networks is requested for a first network slice, and the first request indicates that the user equipment is registered via the plurality of access networks; determines, based on information received from a network slice admission control function in the mobile communication network, that user-plane resources in a first access network in the plurality of access networks cannot be reserved for the first network slice; and sends a response message to the user equipment via the access management function, the response message accepting the multiaccess data connection and including a first indication indicating that user-plane resources over the first access network cannot be reserved.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for multi-access protocol data unit session access type usage;

FIG. 2 is a schematic block diagram illustrating one embodiment of an apparatus that may be used for multi-access protocol data unit session access type usage;

FIG. 3 is a schematic block diagram illustrating one embodiment of an apparatus that may be used for multi-access protocol data unit session access type usage;

FIG. 4 is a schematic block diagram illustrating one embodiment of a system in which a UE requests an MA PDU session over a 3GPP access type;

FIG. 5 is a schematic block diagram illustrating one embodiment of a system for communications for an MA PDU session;

FIG. 6 is a flow chart diagram illustrating one embodiment of a method for multi-access protocol data unit session access type usage; and

FIG. 7 is a flow chart diagram illustrating another embodiment of a method for multi-access protocol data unit session access type usage.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code May be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

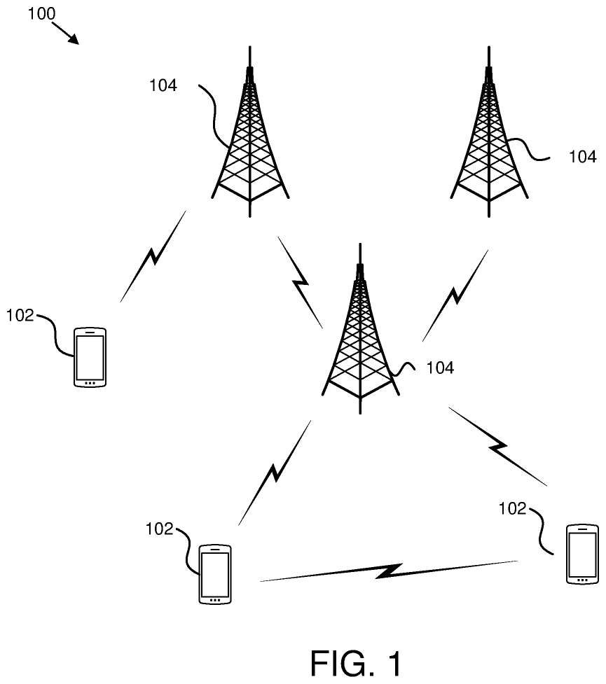

FIG. 1 depicts an embodiment of a wireless communication system 100 for multi-access protocol data unit session access type usage. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may send, to a network, a first request message to establish a multi-access protocol data unit session via a first access type. In some embodiments, the remote unit 102 may receive a response message including an indication for a user plane restriction for a restricted access type. In certain embodiments, the remote unit 102 may determine to use user plane resources only over a non-restricted access type. Accordingly, the remote unit 102 may be used for multi-access protocol data unit session access type usage.

In certain embodiments, a network unit 104 may receive a first request message from an access management function, the first request message including: a second request message from a user equipment to establish a multi-access protocol data unit session with a first network slice subject to network slice admission control; and a first indication that the user equipment is registered for a first access type and a second access type. In some embodiments, the network unit 104 may determine, based on information received from a network slice admission control function, that a restricted access type is unavailable for the first network slice. In certain embodiments, the network unit 104 may transmit a first response message to the user equipment, the first response message indicating that the multi-access protocol data unit session is accepted and a user plane restriction for the restricted access type applies. Accordingly, the network unit 104 may be used for multi-access protocol data unit session access type usage.

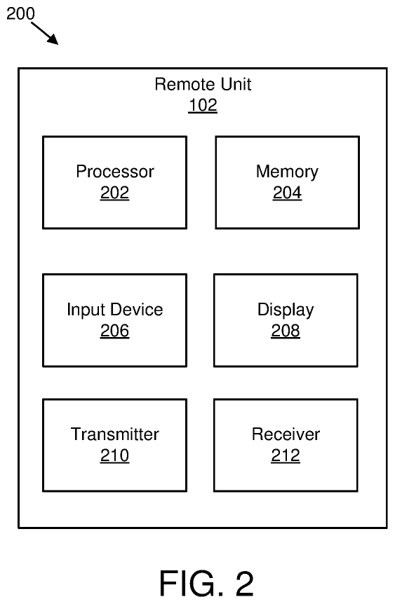

FIG. 2 depicts one embodiment of an apparatus 200 that may be used for multi-access protocol data unit session access type usage. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the transmitter 210 sends, to a network, a first request message to establish a multi-access protocol data unit session via a first access type. In various embodiments, the receiver 212 receives a response message including an indication for a user plane restriction for a restricted access type. In certain embodiments, the processor 202 determines to use user plane resources only over a non-restricted access type.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

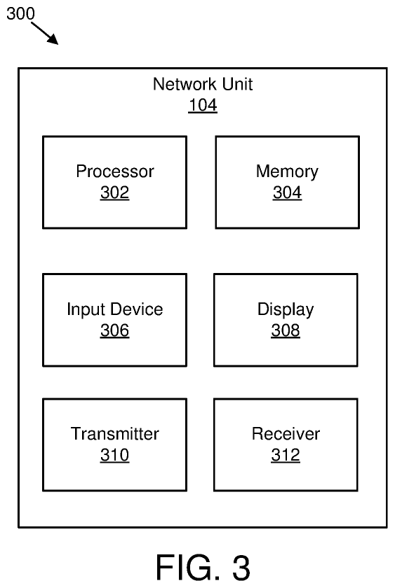

FIG. 3 depicts one embodiment of an apparatus 300 that may be used for multi-access protocol data unit session access type usage. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 communicates with one or more network functions in a mobile communication network. In various embodiments, the processor 302: receives a first request from an access management function in the mobile communication network, the first request comprising a second request sent by a user equipment, wherein the second request indicates that a multiaccess data connection over a plurality of access networks is requested for a first network slice, and the first request indicates that the user equipment is registered via the plurality of access networks; determines, based on information received from a network slice admission control function in the mobile communication network, that user-plane resources in a first access network in the plurality of access networks cannot be reserved for the first network slice; and sends a response message to the user equipment via the access management function, the response message accepting the multiaccess data connection and including a first indication indicating that user-plane resources over the first access network cannot be reserved.

In various embodiments, such as in a fifth generation (“5G”) communication system (“5G System”, “5GS”), network slicing may be supported. In such embodiments, a network slice admission control may be used. Moreover, a network slice identified by a single (“S”) network slice selection assistance information (“NSSAI”) (“S-NSSAI”) may be subject to a network slice admission control (“NSAC”). Further, the NSAC may allow the use of the S-NSSAI resources up to a maximum number of registered user equipments (“UEs”) and/or a maximum number of established protocol data unit (“PDU”) sessions in the S-NSSAI. If the maximum number of registered UEs and/or established PDU sessions in the S-NSSAI are reached, then new UEs or PDU sessions are rejected.

In certain embodiments, a network slice admission control function (“NSACF”) monitors and controls a number of registered UEs per network slice for network slices that are subject to NSAC. In such embodiments, the NSACF may be configured with a maximum number of registered UEs and/or established PDU sessions which are allowed to be served by the S-NSSAI that is subject to NSAC. Moreover, the following may apply: 1) if the NSAC for a maximum number of registered UEs for an S-NSSAI applies, the NSACF and an access and mobility management function (“AMF”) (or for an evolved packet core (“EPC”) the SMF+PGW-C) are configured via an operations, administration, and management (“OAM”) system that an S-NSSAI is subject to NSAC; and/or 2) if the NSAC for a maximum number of PDU session for an S-NSSAI applies, the NSACF and the SMF (or for an EPC the SMF+PGW-C) are configured via the OAM system that an S-NSSAI is subject to NSAC.

In some embodiments, the NSACF monitors (e.g., increases or decreases) a current number of UEs registered with or PDU sessions established in a network slice. In such embodiments, the NSACF may control whether the current number of UEs or PDU sessions exceed a maximum number of UEs allowed to register with or the maximum number of PDU sessions in the network slice.

In various embodiments, 5G networks (e.g., 5GS) support multi access (“MA”) PDU (“MA PDU”) session that is defined to provide a PDU connectivity service, which may use one access network at a time, or simultaneously one 3GPP access network and one non-3GPP access network. In such embodiments, the MA PDU session may have user-plane (“UP”) resources on two access networks. This may assume both 3GPP access and non-3GPP access are allowed for the S-NSSAI of the PDU session.

In certain embodiments, a UE may request a MA PDU session if the UE is registered via both 3GPP and non-3GPP access networks (also called access types), or if the UE is registered via one access network only.

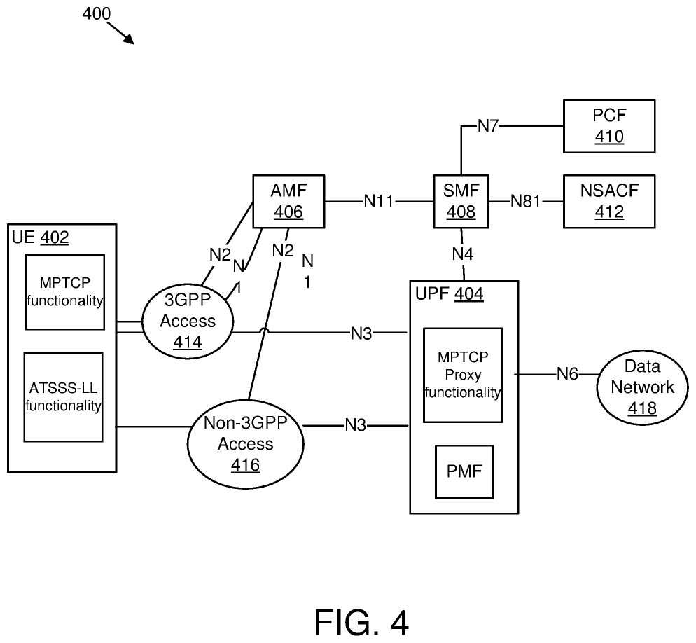

FIG. 4 is a schematic block diagram illustrating one embodiment of a system 400 in which a UE requests an MA PDU session over a 3GPP access type. The system 400 includes a UE 402, a UPF 404, an AMF 406, an SMF 408, a PCF 410, and an NSACF 412. The UE 402 may communicate via 3GPP access network and/or type 414 and/or non-3GPP access network and/or type 416. As it is shown, the UPF 402 may maintain two N3 tunnels towards corresponding 3GPP access network 414 and non-3GPP access network 416. Moreover, the UPF 404 may communicate (e.g., transmit and receive data) with a data network 418.

Further, FIG. 4 shows the system architecture to use a MA PDU session and also the NSACF 412 if an S-NSSAI to which the MA PDU session is established is subject to NSAC. If the UE wants to establish an MA PDU session, the UE 402 includes a request type “MA PDU Request” in an UL NAS transport message which carries a NAN SM PDU session establishment request message. The AMF 406 informs the SMF 408 that the UE 402 is registered over both access types (“ATs”) (e.g., 3GPP access and non-3GPP access). This may trigger the SMF 408 to establish UP resources on both ATs and two N3 (or N9) tunnels between the UPF 404 and the RAN and/or AN.

In certain embodiments, if the S-NSSAI to which an MA PDU session is associated is subject to NSAC, then an SMF needs to send a request to an NSACF to check the availability whether a maximum number of PDU sessions has been reached. Furthermore, the SMF updates the status of number of PDU sessions in the NSACF by including an update flag to increase (e.g., if a PDU session is established towards one or more access networks and/or types) or decrease (e.g., if a PDU session or the user plane resources for one or more access networks and/or types is not used or released) the number of PDU sessions. It may be assumed that for the MA PDU session, the SMF provides one or more Access Type(s) to the NSACF if the user plane is first established or released in the associated access network and/or type. Therefore, for MA PDU session establishment, and if the UE is registered over both ATs (e.g., 3GPP access and non-3GPP access), the SMF sends a request to NSACF including both ATs. The NSACF may increase the count of PDU sessions by two if the NSACF is configured to count the PDU sessions for both ATs; or alternatively or, in addition, the NSACF may count the PDU sessions separately per AT. If a maximum number of PDU sessions in the NSACF for a specific AT has been reached, the NSACF may reject the request for this specific AT.

In some embodiments, an SMF may handle situations in which an NSACF rejects a request from the SMF for one AT, but the other AT is available. In various embodiments herein, a system may be similar to that of FIG. 4, a UE may be capable of establishing a MA PDU session and the UE may be configured correspondingly, and/or there may be a correspondingly configured SMF that is able to serve the MA PDU session.

In certain embodiments, for a MA PDU session, if an NSACF indicates that at least one AT is not available, an SMF may provide to a UE with restriction information (e.g., user plane restriction) for the unavailable access network and/or type (e.g., called AT for short). In other words, the MA PDU session is successfully established, but only limited access networks and/or types out of a plurality of networks and/or types can be used. In such embodiments, the following may apply: 1) the SMF may optionally provide a restricted time value during which the UE should not send signaling to use (e.g., activate or establish) UP resources towards the unavailable AT; 2) if the AT becomes available again, the SMF may send a PDU session management message (e.g., PDU session modification request message) to the UE to delete the UP resource restrictions; and/or 3) if both ATs are not available, the SMF may reject the MA PDU session establishment including an appropriate reject cause (e.g., existing reject cause PDU session rejected due to a maximum number of PDU sessions reached over all ATs) and additional back-off timers (e.g., with different time values) for each access type.

In some embodiments, an SMF may subscribe with a NSACF to be notified if unavailable UP resources become available again. In various embodiments, if a UE receives, from an SMF, a PDU session response message (e.g., accept or reject) over a first AT and UP resources are restricted over the first AT, the UE may determine to send a request to establish the same MA PDU session over a second AT. In such embodiments, if the UE is not registered over the second AT, the UE should first trigger a registration procedure over the second AT.

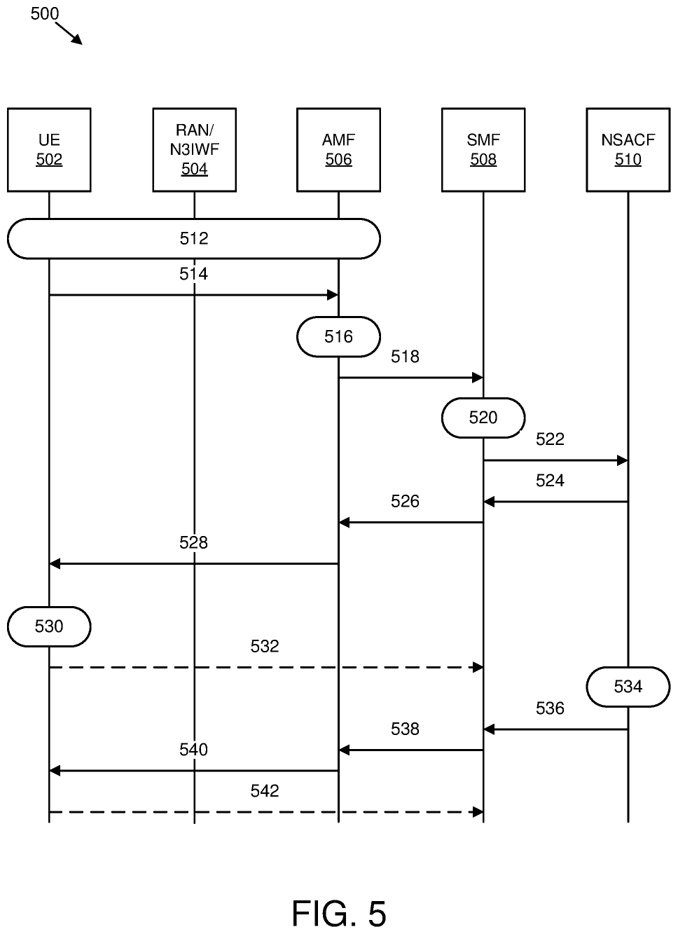

FIG. 5 is a schematic block diagram illustrating one embodiment of a system 500 for communications for an MA PDU session. The system 500 includes a UE 502, a radio access network (“RAN”, representing the 3GPP access type) and/or non-3GPP interworking function (“N3IWF”, representing the non-3GPP or N3GPP access type) 504, an AMF 506, an SMF 508, and a network slice admission control function (“NSACF”) 510. Each of the communications within the system 500 may include one or more messages.

It should be noted that “non-3GPP” access may be equivalent to “N3GPP” access. Such terms may relate to any type of radio or wireline access not specified by the 3GPP organization (e.g., WiFi as specified by the WiFi Alliance organization).

In a first communication 512, the UE 502 registers with the network (e.g., 5GS, the AMF 506). The UE 502 may be registered via a single access type (e.g., 3GPP or N3GPP), or via both access types.

In a second communication 514, the UE 502 determines to establish an MA PDU session. Moreover, the UE 502 sends uplink non-access stratum (“NAS”) mobility management (“MM”) message containing MM parameters and an N1 session management (“SM”) container including a PDU session establishment request. The MM parameters may include at least a request type “MA PDU Request” and a PDU session identifier (“ID”). The PDU session establishment request may include at least a PDU session ID, a requested PDU session type, a 5G SM capability (e.g., including access traffic steering, switching, and splitting (“ATSSS”) capabilities), and so forth.

If the AMF 506 supports MA PDU sessions, then the AMF 506 selects 516 the SMF, which supports MA PDU sessions.

In a third communication 518, the AMF 506 sends to the SMF 508 a request for PDU session establishment. The AMF 506 may use a Nsmf_PDUSession_CreateSMContext request including at least some of the following parameters: subscription permanent identifier (“SUPI”), S-NSSAI, PDU session ID, request type, and/or N1 SM container (e.g., PDU session establishment request). The AMF 506 informs the SMF 508 that the request is for a MA PDU session by including an “MA PDU Request” indication and/or the AMF 506 indicates to the SMF 508 about whether the UE 502 is registered over both accesses.

The SMF 508 retrieves session management subscription data from a UDM to verify whether the MA PDU session is allowed. The SMF 508 may request a PCF to retrieve the policy rules for the PDU session. If the SMF 508 determines that the S-NSSAI to which the requested MA PDU Session is associated with is subject to an NSAC, the SMF 508 triggers 520 an NSAC procedure for a maximum number of PDU sessions.

In a fourth communication 522, the SMF 508 sends a request to the NSACF 510 to check session availability. The SMF 508 may send a Nnsacf_NSAC_NumOfPDUsUpdate request including: SUPI, S-NSSAI, a first access type (“AT1”), a second access type (“AT2”), an update flag, and/or other parameters. The parameters AT1 and AT2 may indicate that the SMF 508 would like to setup UP resources for both access types. For example, the SMF 508 includes both AT1 and AT2 if the SMF 508 is aware that the UE 502 is registered via both AT1 and AT2. However, if the SMF 508 is aware that the UE 502 is only registered via a single access type (“AT”) (e.g., AT1 or 3GPP), the SMF 508 includes only a single AT (e.g., AT1 or 3GPP). If the PDU session is a MA PDU session, the SMF 508 may determine to subscribe to notifications for AT availability. Accordingly, the SMF 508 may include an indication for subscription (e.g., implicit subscription) for notification if an unavailable AT becomes available again.

In a fifth communication 524, the NSACF 510 performs a check and updates (e.g., increase or decrease) a current number of PDU sessions established on an S-NSSAI, a number of PDU sessions based on the S-NSSAI, and update flag parameters (e.g., from step 522). The NSACF 510 may reply to the SMF 508 using the Nnsacf_NSAC_NumOfPDUsUpdate response including parameters: SUPI, S-NSSAI, and/or a result.

20) The NSACF 510 may monitor and/or count the PDU sessions for the S-NSSAI and for AT1 and AT2 independently. In other words, for an S-NSSAI, the NSACF may be configured with a different maximum number of PDU sessions (e.g., different quotas) for AT1 and AT2. If the maximum number of PDU sessions per S-NSSAI has been reached for a specific AT (e.g., AT2), the NSACF 510 includes a result parameter indicating which AT is unavailable (e.g., Result: AT2_unavailable) and may include an indication of the AT that is available (e.g., AT1_available). In such embodiments, the result parameter may include the status for: 1) a whole PDU session, in which case no AT may be included (e.g., the status information ‘available’ or ‘unavailable’ relates to the MA PDU session (e.g., which AT is used); 2) the PDU session and a single AT (e.g., the AT that was requested in step 522 and indicating the status of ‘available’ or ‘unavailable’); and/or 3) the PDU session and multiple ATs, whereas for each AT there is an associated status information ‘available’ or ‘unavailable’. For example, if the SMF 508 has included only AT2 in the request in step 522 and the NSACF 510 determines that the maximum number of PDU sessions is reached for AT2, the NSACF 510 may determine to include in the response to the SMF 508 the information that ‘AT2 is unavailable’ and ‘AT1 is available’. By including the information that ‘AT1 is available’, the NSACF 510 may allow the SMF 508 to provide useful information to the UE 502 for the MA PDU session.

In a sixth communication 526, based on the result parameter received in step 524, the SMF 508 determines how to proceed further with the PDU session establishment procedure. If the result parameter indicates that the PDU session is available (e.g., available for any AT), the SMF 508 continues with the MA PDU session establishment. If the result parameter indicates that the maximum number of single access (“SA”) PDU sessions per S-NSSAI is reached (e.g., independent of the AT, meaning for all or any AT), the SMF 508 may reject the MA PDU session establishment request with reject cause set to “maximum number of PDU sessions per S-NSSAI reached” and optionally a back-off timer which applies for the whole MA PDU session. The UE 502 does not initiate the establishment of the PDU session to the same S-NSSAI for the time value of the back-off timer.

In various embodiments, for example if both ATs are not available and different congestion levels are experienced per AT, the SMF 508 may reject the MA PDU session establishment including the corresponding reject cause (e.g., existing reject cause PDU session rejected due to a maximum number of PDU sessions reached) but a back-off timer is provided for each access type. In other words, the back-off timers would have different time values, and thus, the UE 502 may determine to send a new MA PDU session establishment request over an AT if the corresponding back-off timer expires.

In certain embodiments, for a MA PDU session, if the NSACF 510 indicated that the PDU session is not available for a single AT, the SMF 508 may include information about user plane resource restrictions (e.g., UP_restrictions) in the N1 SM PDU session establishment response message to the UE 502. The UP_restrictions may be applicable to a single or multiple access types, meaning that the user plane associated with the access type temporarily cannot be used. In addition, the SMF 508 may optionally include a restricted time (e.g., Restricted_Time) value associated with the UP resource restrictions. The N1 SM PDU session establishment response message may be a PDU session establishment accept message or PDU session establishment reject message.

In some embodiments, if the MA PDU session management request message is sent over one AT (e.g., AT1, 3GPP access) and the NSACF 510 has rejected this AT (e.g., AT1, 3GPP), the SMF 508 may perform the following: 1) if the SMF 508 has received in step 518 an indication from the AMF 506 that the UE 502 is currently registered to multiple ATs (e.g., AT1, 3GPP) and AT2 (e.g., N3GPP) accesses, the SMF 508 may determine to send a PDU session establishment accept message including the UP_restrictions for AT1—the SMF 508 sends an accept message because the MA PDU session is allowable over the N3GPP access to which the UE 502 is registered; and/or 2) if the SMF 508 has received in step 518 an indication from the AMF 506 that the UE 502 is currently registered to both 3GPP access only, the SMF 508 may determine to send a PDU session establishment reject message including the UP_restrictions. The SMF 508 sends a reject message because the MA PDU session is allowable over the N3GPP access, to which the UE 502 is not registered.

In various embodiments, the SMF 508 sends to the AMF 506 a message carrying the N1 SM container and the N2 SM Information container. The N1 SM container contains the PDU session response message which includes the UP_restrictions and associated Restricted_Time. The PDU session response message can be PDU session establishment accept message or PDU session establishment reject message. The SMF 508 uses the Namf_Communication_NIN2MessageTransfer request service operation.

In a seventh communication 528, the AMF 506 delivers to the UE 502 the N1 SM container received from the SMF 508. Furthermore, the AMF 506 delivers to the AN the N2 SM information container received from the SMF 508.

The UE 502 applies 530 the received session management response message from the SMF 508 including the UP_restrictions (e.g., associated with the restricted one or more AT(s)) and optionally the restricted time as per step 526. The UE 502 stores the UP_restrictions and does not initiate NAS SM signaling to use the restricted UP resources associated with the restricted AT(s) (e.g., as indicated in the UP_restrictions) until one of the following applies: 1) receiving signaling from the SMF 508 to remove and/or delete the UP_restrictions and associated Restricted_Time (e.g., as shown in step 540); or 2) until the associated Restricted_Time expires. For example, the UE 502 does not send signaling to establish or activate the MA PDU session over the restricted AT. When the Restricted_Time expires, the UE 502 may delete the stored UP restrictions. In other words, if the session management response message indicates accept and a single AT is restricted, the UE 502 uses the MA PDU session (e.g., activates UP resources and sends and/or receives the SM signaling) only over the access type leg for which the UP resources are available (e.g., not restricted). The UE 502 may only use the MA PDU session over AT1 (e.g., because the result parameter indicated AT1_available). It should be noted that the session management response message may be a PDU session establishment accept or PDU session establishment reject message.

In an optional eighth communication 532, if the UE 502 receives from the SMF 508 a PDU session response message over a first AT (e.g., 3GPP AT or AT1, it should be noted that this is a different assumption compared to communications 524 and 526 where AT1 was available) and the UP resources are restricted over the first AT (e.g., AT1), the UE 502 may determine to send a request to establish the same MA PDU session over a second AT (e.g., non-3GPP AT or AT2). If the UE 502 is not registered over the second AT (e.g., AT2), the UE 502 should first trigger a registration procedure over the second AT (e.g., AT2) and also register with the same S-NSSAI to which the MA PDU session from step 514 was triggered. In other words, the UE 502 may include the S-NSSAI in the requested NSSAI in the registration request message over the AT2.

The NSACF 510 determines 534 that PDU sessions can be established over AT2 (e.g., AT2 is available again). For example, the current number of PDU sessions has undergone the maximum number PDU sessions for the access type (e.g., AT2).

In a nineth communication 536, the NSACF 510 sends to the SMF 508, which has subscribed before (e.g., see step 522), a notification that the PDU sessions for the S-NSSAI and AT2 are available again. For example, the NSACF 510 may use the following service operation transmitted towards the SMF 508: Nnsacf_NSAC_NumOfPDUsUpdate_Notify (e.g., S-NSSAI, AT2_available) indicating that the PDU sessions associated with the S-NSSAI are available again over AT2.

In a tenth communication 538, an eleventh communication 540, and/or an optional twelfth communication 542, the SMF 508 may update the UE 502 and indicate that the access leg over AT2 is available again. For example, the SMF 508 may send a PDU session modification request message which deletes and/or removes the UP_restrictions installed during steps 526 and/or 528. The SMF 508 may indicate that for this MA PDU session there are no more restrictions associated with AT2 (e.g., by sending parameter Delete_UP_restrictions_AT2). Alternatively, in some embodiments, in the tenth communication 538, the SMF 508 may determine to initiate the activation of the UP resources over AT2; and therefore, when the UE 502 is configured to use the UP resources over AT2, the UE 502 may determine that the UP resources associated with AT2 are available again. In such embodiments, the UE may assume that the restricted time is expired and internally delete the UP restrictions associated with AT2.

For steps 538, 540, and/or 542, the SMF 508 may need to store information that the parameter UP_restrictions_AT2 has been sent to the UE 502. In other words, the SMF 508 stores in the UE SM context a state with the information that has been configured in the UE 502, especially the UP restrictions information.

In the twelfth communication 542, after receiving the update 540 from the SMF 508, the UE 502 may determine to initiate session management signaling to the AMF 506 and/or SMF 508 to activate the user plane resources over the AT2.

It should be noted that a method for the SMF 508 to be updated and/or notified by the NSACF 510 for available PDU sessions and corresponding AT may be applied to single access PDU sessions. If the NSACF 510 does not store the AT, as send by the SMF 508 in step 522, the NSACF 510 provides an indication that the S-NSSAI is available for new PDU sessions (e.g., the current number of PDU sessions has undergone a maximum number PDU sessions (e.g., for any AT)).

It should be noted that if a single access (“SA”) PDU session is rejected to the UE 502 (e.g., where the UE 502 has requested the PDU session establishment via AT1) and if the UE's UE route selection policy (“URSP”) rules allow the use of AT2, the UE 502 may determine to trigger establishment of a SA PDU session for the AT2. As may be appreciated, various benefits of embodiments of FIG. 5 may offer flexibility to inform a UE about a temporary unavailability of UP resources associated with an access type. This may enable the UE to still use the UP resources of the MA PDU session for the access type to which there are no restrictions.

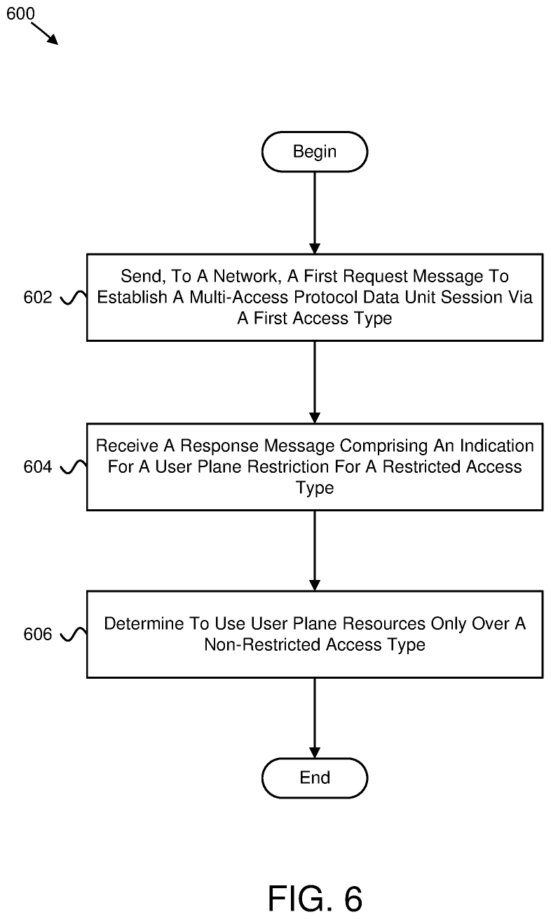

FIG. 6 is a flow chart diagram illustrating one embodiment of a method 600 for multi-access protocol data unit session access type usage. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes sending 602, from a user equipment to a network, a first request message to establish a multi-access protocol data unit session via a first access type. In some embodiments, the method 600 includes receiving 604 a response message including an indication for a user plane restriction for a restricted access type. In certain embodiments, the method 600 includes determining 606 to use user plane resources only over a non-restricted access type.

In certain embodiments, the user plane restriction applies only if there is at least one available access type, and the response message is a protocol data unit session establishment accept message. In some embodiments, the user plane restriction applies to deployed access types, and the response message is a protocol data unit session establishment reject message. In various embodiments, the response message being received over the first access type indicates that the user plane restriction applies to the first access type, and the method further comprises sending a second request to establish the multi-access protocol data unit session over a second access type.

In one embodiment, the method 600 further comprises, in addition to the user plane restriction, receiving a restricted time value indicating a time for which the user plane restriction via the restricted access type is not available, and wherein, in response to the user plane restrictions applying to multiple access types, the restricted time value is associated with each unavailable access type. In certain embodiments, the method 600 further comprises determining to not send a request for the multi-access protocol data unit session over the restricted access type while the time value is running.

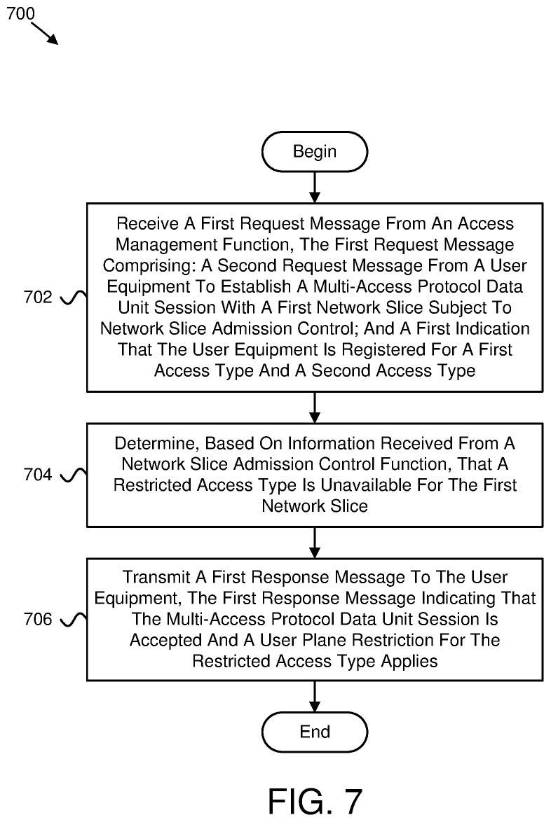

FIG. 7 is a flow chart diagram illustrating one embodiment of a method 700 for multi-access protocol data unit session access type usage. In some embodiments, the method 700 is performed by an apparatus, such as the network unit 104. In certain embodiments, the method 700 may be performed by a processor executing program code, for example, a microcontroller, a microprocessor, a CPU, a GPU, an auxiliary processing unit, a FPGA, or the like.

In various embodiments, the method 700 includes receiving 702, at a network function, a first request message from an access management function, the first request message including: a second request message from a user equipment to establish a multi-access protocol data unit session with a first network slice subject to network slice admission control; and a first indication that the user equipment is registered for a first access type and a second access type. In some embodiments, the method 700 includes determining 704, based on information received from a network slice admission control function, that a restricted access type is unavailable for the first network slice. In certain embodiments, the method 700 includes transmitting 706 a first response message to the user equipment, the first response message indicating that the multi-access protocol data unit session is accepted and a user plane restriction for the restricted access type applies.

In certain embodiments, the method 700 further comprises, in addition to the user plane restriction, transmitting a restricted time value associated with the user plane restriction for the restricted access type. In some embodiments, the method 700 further comprises initiating establishment of user plane resources for a non-restricted access type.

In various embodiments, determining based on information received from a network slice admission control function further comprises: sending a third request message to the network slice admission control function requesting availability for the first network slice and indication of a plurality of access types, wherein the third request message creates an implicit subscription with the network slice admission control function for notification for availability in response to an access type currently being not available; and receiving a second response message from the network slice admission control function indicating that an access type is restricted for the first network slice. In one embodiment, the method 700 further comprises receiving a notification message from the network slice admission control function indicating that the restricted access type is available again, and initiating: a modification procedure transmitted towards the user equipment to delete the user plane restriction for the restricted access type; establishment of user plane resources for the restricted access type; or a combination thereof.

In one embodiment, a method of a user equipment comprises: sending, to a network, a first request message to establish a multi-access protocol data unit session via a first access type; receiving a response message comprising an indication for a user plane restriction for a restricted access type; and determining to use user plane resources only over a non-restricted access type.

In certain embodiments, the user plane restriction applies only if there is at least one available access type, and the response message is a protocol data unit session establishment accept message.

In some embodiments, the user plane restriction applies to deployed access types, and the response message is a protocol data unit session establishment reject message.

In various embodiments, the response message being received over the first access type indicates that the user plane restriction applies to the first access type, and the method further comprises sending a second request to establish the multi-access protocol data unit session over a second access type.

In one embodiment, the method further comprises, in addition to the user plane restriction, receiving a restricted time value indicating a time for which the user plane restriction via the restricted access type is not available, and wherein, in response to the user plane restrictions applying to multiple access types, the restricted time value is associated with each unavailable access type.

In certain embodiments, the method further comprises determining to not send a request for the multi-access protocol data unit session over the restricted access type while the time value is running.

In one embodiment, an apparatus comprises a user equipment. The apparatus further comprises: a transmitter that sends, to a network, a first request message to establish a multi-access protocol data unit session via a first access type; a receiver that receives a response message comprising an indication for a user plane restriction for a restricted access type; and a processor that determines to use user plane resources only over a non-restricted access type.

In certain embodiments, the user plane restriction applies only if there is at least one available access type, and the response message is a protocol data unit session establishment accept message.

In some embodiments, the user plane restriction applies to deployed access types, and the response message is a protocol data unit session establishment reject message.

In various embodiments, the response message being received over the first access type indicates that the user plane restriction applies to the first access type, and the transmitter sends a second request to establish the multi-access protocol data unit session over a second access type.

In one embodiment, the receiver, in addition to the user plane restriction, receives a restricted time value indicating a time for which the user plane restriction via the restricted access type is not available, and, in response to the user plane restrictions applying to multiple access types, the restricted time value is associated with each unavailable access type.

In certain embodiments, the processor determines to not send a request for the multi-access protocol data unit session over the restricted access type while the time value is running.

In one embodiment, a method of a network function comprises: receiving a first request message from an access management function, the first request message comprising: a second request message from a user equipment to establish a multi-access protocol data unit session with a first network slice subject to network slice admission control; and a first indication that the user equipment is registered for a first access type and a second access type; determining, based on information received from a network slice admission control function, that a restricted access type is unavailable for the first network slice; and transmitting a first response message to the user equipment, the first response message indicating that the multi-access protocol data unit session is accepted and a user plane restriction for the restricted access type applies.

In certain embodiments, the method further comprises, in addition to the user plane restriction, transmitting a restricted time value associated with the user plane restriction for the restricted access type.

In some embodiments, the method further comprises initiating establishment of user plane resources for a non-restricted access type.

In various embodiments, determining based on information received from a network slice admission control function further comprises: sending a third request message to the network slice admission control function requesting availability for the first network slice and indication of a plurality of access types, wherein the third request message creates an implicit subscription with the network slice admission control function for notification for availability in response to an access type currently being not available; and receiving a second response message from the network slice admission control function indicating that an access type is restricted for the first network slice.

In one embodiment, the method further comprises receiving a notification message from the network slice admission control function indicating that the restricted access type is available again, and initiating: a modification procedure transmitted towards the user equipment to delete the user plane restriction for the restricted access type; establishment of user plane resources for the restricted access type; or a combination thereof.

In one embodiment, an apparatus comprises a network function. The apparatus further comprises: a transmitter that communicates with one or more network functions in a mobile communication network; and a processor that: receives a first request from an access management function in the mobile communication network, the first request comprising a second request sent by a user equipment, wherein the second request indicates that a multiaccess data connection over a plurality of access networks is requested for a first network slice, and the first request indicates 20) that the user equipment is registered via the plurality of access networks; determines, based on information received from a network slice admission control function in the mobile communication network, that user-plane resources in a first access network in the plurality of access networks cannot be reserved for the first network slice; and sends a response message to the user equipment via the access management function, the response message accepting the multiaccess data connection and comprising a first indication indicating that user-plane resources 25 over the first access network cannot be reserved.

In certain embodiments, the response message further comprises a timer indicating to the user equipment that establishment of user-plane resources in the first access network cannot be reserved for a given time period.

In some embodiments, the processor further initiates establishment of user-plane resources for all access networks in the plurality of access networks except the first access network.

In various embodiments, determining from the network slice admission control function in the mobile communication network that user-plane resources in the first access network in the plurality of access networks cannot be reserved for the first network slice further comprises: sending a first message to the network slice admission control function requesting admission control information for the first network slice and the plurality of access networks, wherein the first message creates an implicit subscription with the network slice admission control function; and receiving a second message from the network slice admission control function indicating that user-plane resources in the first access network in the plurality of access networks cannot be reserved for the first network slice.

In one embodiment, the apparatus further comprises: receiving a notification message from the network slice admission control function indicating that user-plane resources in the first access network can be reserved for the first network slice; and initiating establishment of user-plane resources for the first access network.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

Please make the following amendments to the claims:

1. A method performed by a user equipment (UE), the method comprising:
registering the UE to a network via a first access type and a second access type;
sending, to a network, a first request message to establish a multi-access (MA) protocol data unit (PDU) session via the first access type on a network slice;
receiving a response message comprising at least one of: a first indication that a maximum number of PDU sessions for the network slice is reached, a second indication for a back-off timer, and a third indication of the first access type; and
determining to not initiate establishment of the MA PDU session over the first access type and using the second access type to establish the MA PDU session.

2. The method of claim 1, wherein the response message is a PDU session establishment reject message.

3. The method of claim 1, further comprising sending a second request to establish the multi-access protocol data unit session over the second access type.

4. The method of claim 2, wherein the second indication for a back-off timer applies only for the first access type.

5. The method of claim 4, further comprising determining to not send a request for the multi-access protocol data unit session over a restricted access type while the time value is running.

6. (canceled)

7. (canceled)

8. (canceled)

9. (canceled)

10. (canceled)

11. An apparatus for performing a network function, the apparatus comprising:
at least one memory; and
at least one processor coupled with the at least one memory and configured to cause the apparatus to:
communicate with one or more network functions in a mobile communication network; and
receive a first request from an access management function in the mobile communication network, the first request comprising a request for multiaccess (MA) protocol data unit (PDU) session for a network slice sent by a user equipment (UE) over a first access type, and the first request indicates that the UE is registered via the first access type and via a second access types;
send a second request to a network slice admission control function (NSACF) including an indication to increase a number of PDU sessions for the network slice and indications of the first access type and the second access type;
receive a first response from the NSACF indicating a failure due to a maximum number of PDU sessions for the network slice is reached over one or more access types; and
send a second response message to the UE depending on a failed access type in the first response.

12. The apparatus of claim 11, wherein the second response message further comprises a timer indicating to the UE that establishment of user-plane resources in the first access type cannot be reserved for a given time period.

13. The apparatus of claim 12, wherein the at least one processor is configured to cause the apparatus to initiate establishment of user-plane resources for all access types except the first access type.

14. The apparatus of claim 13, wherein the at least one processor is configured to cause the apparatus to determine from the network slice admission control function in the mobile communication network that user-plane resources in the first access type cannot be reserved for a first network slice by:
sending a first message to the network slice admission control function requesting admission control information for the first network slice, wherein the first message creates an implicit subscription with the network slice admission control function; and
receiving a second message from the network slice admission control function indicating that user-plane resources in the first access type cannot be reserved for the first network slice.

15. The apparatus of claim 14, wherein the at least one processor is configured to cause the apparatus to:
receive a notification message from the network slice admission control function indicating that user-plane resources in the first access type can be reserved for the first network slice; and
initiate establishment of user-plane resources for the first access type.

16. A user equipment (UE), comprising:
at least one memory; and
at least one processor coupled with the at least one memory and configured to cause the UE to:
register the UE to a network via a first access type and a second access type;
send, to a network, a first request message to establish a multi-access (MA) protocol data unit (PDU) session via the first access type on a network slice;
receive a response message comprising at least one of: a first indication that a maximum number of PDU sessions for the network slice is reached, a second indication for a back-off timer, and a third indication of the first access type; and
determine to not initiate establishment of the MA PDU session over the first access type and using the second access type to establish the MA PDU session.

17. The UE of claim 16, wherein the response message is a PDU session establishment reject message.

18. The UE of claim 16, wherein the at least one processor is configured to cause the UE to send a second request to establish the multi-access protocol data unit session over the second access type.

19. The UE of claim 17, wherein the second indication for a back-off timer applies only for the first access type.

20. The UE of claim 19, wherein the at least one processor is configured to cause the UE to determine to not send a request for the multi-access protocol data unit session over a restricted access type while the time value is running.

21. A processor for wireless communication, comprising:
at least one controller coupled with at least one memory and configured to cause the processor to:
register the processor to a network via a first access type and a second access type;
send, to a network, a first request message to establish a multi-access (MA) protocol data unit (PDU) session via the first access type on a network slice;
receive a response message comprising at least one of: a first indication that a maximum number of PDU sessions for the network slice is reached, a second indication for a back-off timer, and a third indication of the first access type; and
determine to not initiate establishment of the MA PDU session over the first access type and using the second access type to establish the MA PDU session.

22. The processor of claim 21, wherein the response message is a PDU session establishment reject message.

23. The apparatus of claim 11, wherein, as a result of the first response indicating that the failure is for the first access type, the second response message is a MA PDU session reject message comprising at least one of: an indication that the maximum number of PDU sessions for the network slice is reached, the first access type, and a back-off timer.

24. The apparatus of claim 11, wherein, as a result of the first response indicating that the failure is for the first access type and the second access type, the second response message is a MA PDU session reject message comprising at least one of: an indication that the maximum number of PDU sessions for the network slice is reached, the first access type, and a back-off timer.

25. The apparatus of claim 11, wherein, as a result of the first response indicating that the failure is for the second access type, the second response message is a MA PDU session accept message.
